(19) United States
(12) Patent Application Publication
(10) Pub. No.: US 2026/0147211 A1
(43) Pub. Date: May 28, 2026

(54) EYEWEAR DISPLAY WITH DUAL LCOS LIGHT ENGINE SYSTEM

(71) Applicant: GOOGLE LLC, Mountain View, CA (US)

(72) Inventor: Thomas Hoekman, Redwood City, CA (US)

(21) Appl. No.: 19/396,995

(22) Filed: Nov. 21, 2025

Related U.S. Application Data
(60) Provisional application No. 63/725,326, filed on Nov. 26, 2024.

(51) Int. Cl. G02B 27/01; G02B 27/00; G02B 27/12; G02B 27/28; G02F 1/1335

(52) U.S. Cl. CPC G02B 27/0172; G02B 27/0081; G02B 27/126; G02B 27/283; G02F 1/133524; G02F 1/133616; G02B 2027/0178

(57) ABSTRACT

A light engine of an eyewear display includes two liquid crystal on silicon (LCoS) panels that are orthogonally arranged with respect to one another, each LCOS panel configured to receive one polarization of a plurality of polarizations of light emitted from a light emitting diode (LED) illumination module. The light engine modulates the light received from the LED illumination module and propagates the light toward a waveguide arranged in a lens of the eyewear display.

### BACKGROUND

In some extended reality (XR) eyewear displays, such as augmented reality (AR) or virtual reality (VR) eyewear displays, display light beams emitted from an image source are coupled into a waveguide by an incoupler, which can be formed as an optical grating or a prism on a surface of the waveguide. Once the display light beams have been coupled into the waveguide, the incoupled display light beams are “guided” through the waveguide, typically by multiple instances of total internal reflection (TIR), expanded in at least one direction by an exit pupil expander, and then directed out of the waveguide by an outcoupler, which can also be formed as an optical grating or prism on a surface of the waveguide. The outcoupled display light beams overlap at an eye relief distance from the waveguide, forming an exit pupil within which a virtual image generated by the image source can be viewed by the user of the eyewear display.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 shows an example of an eyewear display, in accordance with some embodiments.

FIG. 2 shows an example of a projection system in the eyewear display of FIG. 1 employing a light engine with two liquid crystal on silicon (LCoS) panels, in accordance with some embodiments.

FIG. 3 shows an example of the propagation of light in the light engine with two LCoS panels of FIG. 2, in accordance with some embodiments.

FIG. 4 shows an example of a portion of the eyewear display of FIG. 1 with the projection system of FIG. 2, including the light engine of FIG. 3, in accordance with some embodiments.

FIG. 5 shows an example of a flowchart describing a method to propagate light from a light engine employing two LCoS panels to an incoupler of a waveguide, in accordance with some embodiments.

### DETAILED DESCRIPTION

Some eyewear displays employ a liquid crystal on silicon (LCoS) panel to propagate light from a light source to the waveguide. LCoS panels work by reflecting light off a silicon backplane coated with a liquid crystal layer. The backplane includes an array of tiny reflective mirrors (or pixels) that control the reflected light intensity by modulating the polarization of reflected light through the liquid crystal layer. Generally, LCoS panels are employed in connection with a polarized light source (and in some cases, one or more filters) to ensure that only the desired light is propagated from the LCoS panel to generate the desired image. In an eyewear display, this reflected image can then pass through other optical components (e.g., lenses, prisms, or the like) before being incoupled at the waveguide and eventually outcoupled to the user. Thus, LCoS panels are polarization-dependent and generally require incident light to be linearly polarized. If the light source (also referred to herein as the “illumination module”) utilizes light-emitting diodes (LEDs), which generate unpolarized light, half of the emitted flux needs to be absorbed and converted by a polarizer before being directed to the LCoS panel. For this reason, conventional eyewear displays employ polarization recycling elements in the light engine to convert all the emitted LED light into a useful polarization state for the LCoS panel. The conventional approach to polarization recycling utilizes a polarization beam splitter (PBS), a half-wave plate (HWP), and a mirror. In some cases, the HWP is replaced by a quarter-wave plate (QWP) in dual-pass systems. While such conventional systems are effective at recycling the unwanted polarization, they double the etendue of the system. Furthermore, the conventional approach to include a PBS and polarization conversion elements can significantly increase both the track length and the total volume of the projection system, which is problematic for eyewear displays, such as AR eyewear displays, which seek to realize a socially acceptable form factor. Thus, the conventional approaches to polarization recycling in the illumination module typically increase the size of the projection system and therefore have form factor drawbacks. Alternative conventional architectures that do not increase system etendue but rely on efficient scattering from the LEDs to recycle polarization are typically limited to efficiency gains of 30% or less.

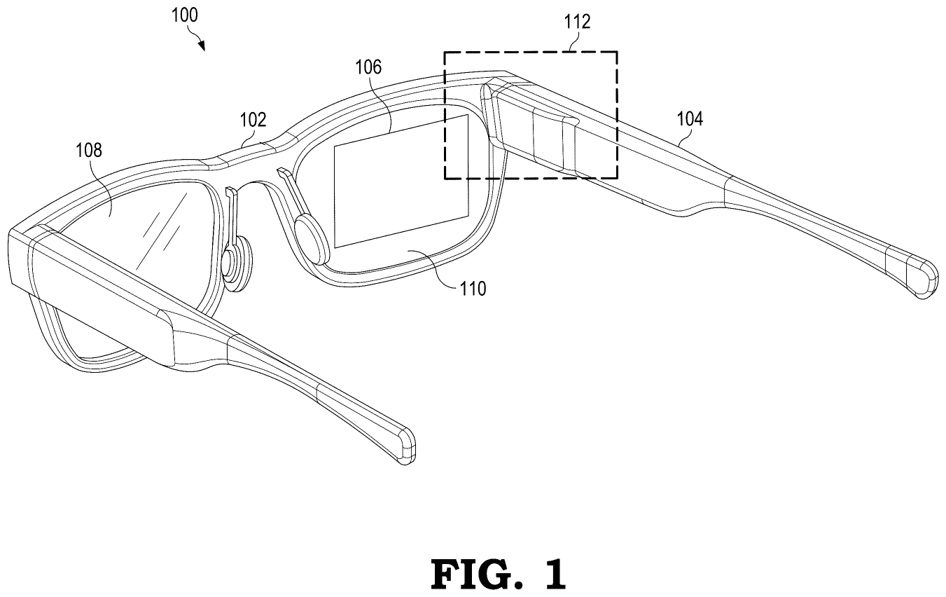

FIGS. 1-5 provide a dual LCoS-based light engine design that utilizes two LCoS panels to operate independently on orthogonal polarization states of light emitted from an LED-based illumination module. The two imaging paths are combined in a small package by utilizing a polarization beam splitter (PBS) cube, thereby resulting in full polarization utilization of light emitted from the LED illumination module within a small form factor.

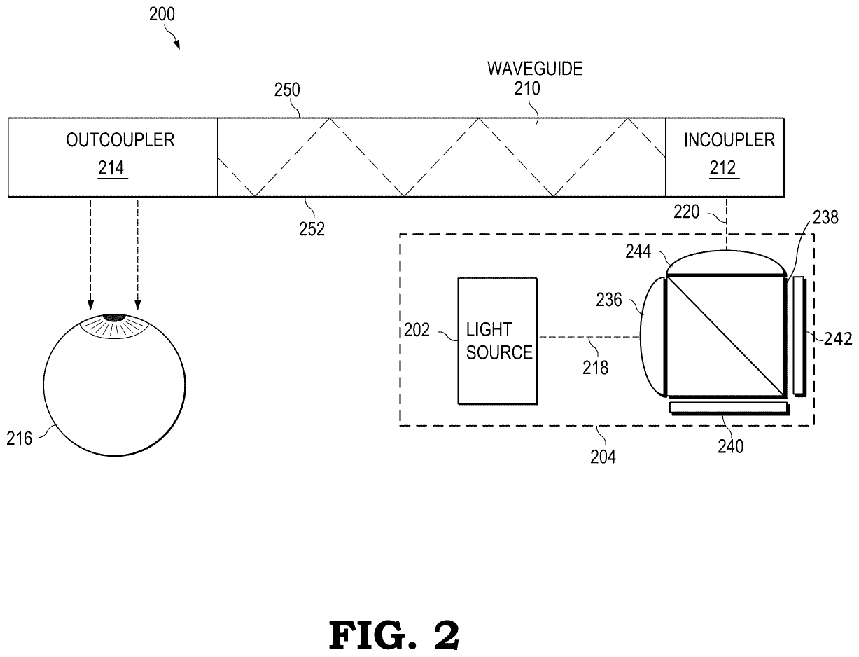

FIG. 1 illustrates an example eyewear display 100 employing a dual-LCoS panel light engine in accordance with various embodiments. The eyewear display 100 (also referred to as a wearable heads up display (WHUD), head-mounted display (HMD), near-eye display, or the like) has a support structure 102 that includes an arm 104, which houses a micro-display projection system configured to project images towards the eye of a user, such that the user perceives the projected images as being displayed in a field of view (FOV) 106 of a display at one or both of lens elements 108, 110. In the depicted embodiment, the support structure 102 of the eyewear display 100 is configured to be worn on the head of a user and has a general shape and appearance (i.e., “form factor”) of an eyeglasses frame. The support structure 102 contains or otherwise includes various components to facilitate the projection of such images towards the eye of the user, such as a light engine including a light source (or illumination module), one or more lenses, LCoS panels, prisms, mirrors, or other optical components, and a waveguide (shown in FIG. 2, for example). In some embodiments, the support structure 102 further includes various sensors, such as one or more front-facing cameras, rear-facing cameras, other light sensors, motion sensors, accelerometers, and the like. The support structure 102 can further include one or more radio frequency (RF) interfaces or other wireless interfaces, such as a Bluetooth™ interface, a WiFi interface, and the like. Further, in some embodiments, the support structure 102 includes one or more batteries or other portable power sources for supplying power to the electrical components of the eyewear display 100. In some embodiments, some or all of these components of the eyewear display 100 are fully or partially contained within an inner volume of support structure 102, such as within the arm 104 in region 112 of the support structure 102. It should be noted that while an example form factor is depicted, it will be appreciated that in other embodiments, the eyewear display 100 may have a different shape and appearance from the eyeglasses frame depicted in FIG. 1.

In some embodiments, one or both of the lens elements 108, 110 are used by the eyewear display 100 to provide a mixed reality (MR) or an augmented reality (AR) display in which rendered graphical content can be superimposed over or otherwise provided in conjunction with a real-world view as perceived by the user through the lens elements 108, 110. In some embodiments, one or both of lens elements 108, 110 serve as optical combiners that combine environmental light (also referred to as ambient light) from outside of the eyewear display 100 and light emitted from an image source in the light engine of the eyewear display 100. For example, light used to form a perceptible image or series of images may be projected by the image source (e.g., the LCoS panels) of the eyewear display 100 onto the eye of the user via a series of optical elements, such as a waveguide formed at least partially in the corresponding lens element,, lenses, scan mirrors, optical relays, prisms, or the like. In some embodiments, the image source is configured to emit light having a plurality of wavelength ranges, e.g., red light, green light, and blue light (collectively referred to as RGB light). The light engine includes the light source (e.g., one or more LEDs) and the image source (e.g., the LCoS panels) as well as other optical components (e.g., one or more lenses, a PBS cube, or the like) to propagate the light toward an incoupler of the waveguide. The incoupler of the waveguide receives this light and incouples it into the waveguide. One or both of the lens elements 108, 110 thus includes at least a portion of a waveguide that routes display light received by the incoupler of the waveguide to an outcoupler of the waveguide, which outputs the display light towards an eye of a user of the eyewear display 100. The display light is modulated and projected onto the eye of the user such that the user perceives the display light as an image in FOV 106. In addition, in some embodiments, each of the lens elements 108, 110 is sufficiently transparent to allow a user to see through the lens elements to provide a field of view of the user's real-world environment such that the image appears superimposed over at least a portion of the real-world environment.

In some embodiments, the light source (or illumination module) is a modulative light source such as a laser projector or a display panel having one or more light-emitting diodes (LEDs) or organic light-emitting diodes (OLEDs) (e.g., a micro-LED display panel or the like) located in region 112. In the illustrated embodiment, the region 112 is illustrated as being in the right temple side of the support structure 102. In other embodiments, the region 112 is additionally or alternatively located on the left temple side of the support structure 102. In some embodiments, the light source is configured to emit RGB light. The light source is communicatively coupled to the controller (not shown) and a non-transitory processor-readable storage medium or memory storing processor-executable instructions and other data that, when executed by the controller, cause the controller to control the operation of the light source. In addition, the controller is also coupled to the image source, such as the two LCoS panels described herein. Each one of the LCoS panels includes a layer of liquid crystals over a silicon backplane that includes an array of pixel electrodes. The controller controls the states of the pixel electrodes, which in turn control the orientation of the liquid crystals in the liquid crystal layer to modulate how much light is reflected at each pixel to form the image. In some embodiments, the controller controls a display area size and display area location for the image source and is communicatively coupled to the image source that generates virtual content to be displayed at the eyewear display 100. In some embodiments, the image source emits light over a variable area, designated the FOV 106, of the eyewear display 100. The variable area corresponds to the size of the FOV 106, and the variable area location corresponds to a region of one of the lens elements 108, 110 at which the FOV 106 is visible to the user. Generally, it is desirable for a display to have a wide FOV 106 to accommodate the outcoupling of light across a wide range of angles.

FIG. 2 illustrates an example of a projection system 200 that projects images onto an eye 216 of a user in accordance with various embodiments. The projection system 200, which may be implemented in the eyewear display 100 in FIG. 1, includes a light engine 204 with a light source 202 and a waveguide 210. In the illustrated embodiment, the light engine 204 also includes two lenses 236, 244, a PBS cube 238, and two LCoS panels 240, 242. The waveguide 210 includes an incoupler 212 and an outcoupler 214, with the outcoupler 214 being optically aligned with an eye 216 of a user. For example, the outcoupler 214 substantially overlaps or corresponds with the FOV 106 shown in FIG. 1. For purposes of clarity, FIG. 2 illustrates the projection system 200 with respect to propagating display light from the light source 202 to one eye 216 of the user. In some embodiments, the projection system 200 includes a similar configuration to propagate display light from the same light source 202 to a second eye of the user (not shown in FIG. 2). That is, another waveguide (not shown in FIG. 2) is included to direct light from the light source 202 to the user's second eye.

In some embodiments, the light source 202 (such as an LED illumination module, such as a micro-LED display) includes one or more light sources configured to generate and project display light 218 (e.g., visible light such as red, blue, and green light and, in some embodiments, non-visible light such as infrared light). In some embodiments, the light source 202 and the two LCoS panels 240, 242 are coupled to a driver or other controller (not shown), which controls the timing of emission of display light from the light source 202 and controls the two LCoS panels 240, 242 in accordance with instructions received by the controller or driver from a computer processor coupled thereto to modulate the display light 218 to be perceived as images when output to the retina of an eye 216 of a user. For example, during operation of the projection system 200, one or more beams of display light 218 are output by the LEDs of the light source 202, modulated by the LCoS panels 240, 242, and then directed into the waveguide 210 before being directed to the eye 216 of the user. The light source 202 and/or the LCoS panels 240, 242 modulate the respective intensities of the light beams 218 so that the combined light reflects a series of pixels of an image, with the particular intensity of each light beam at any given point in time contributing to the amount of corresponding color content and brightness in the pixel being represented by the combined light at that time.

In some embodiments, the light source 202 is an LED-based illumination module that transmits unpolarized light 218. The light engine 204 also includes two LCoS panels 240, 242 to operate independently on orthogonal polarization states of light emitted from the LED-based illumination module serving as the light source 202. The two imaging paths (each corresponding to one of the LCoS panels 240, 242) are combined in a small package by utilizing the PBS cube 238, thereby resulting in full polarization utilization within a small form factor.

In some embodiments, the light engine 204 includes fewer or more optical components than those depicted in FIG. 2. For example, in some embodiments, the light engine 204 includes additional lenses in addition to lenses 236, 244.

As illustrated in FIG. 2, the waveguide 210 of the projection system 200 includes the incoupler 212 and the outcoupler 214. The term “waveguide,” as used herein, will be understood to mean a combiner using one or more of total internal reflection (TIR), specialized filters, or reflective surfaces, to transfer light from an incoupler (such as incoupler 212) to an outcoupler (such as the outcoupler 214). In some display applications, the light is a collimated image, and the waveguide 210 transfers and replicates the collimated image to the eye. In general, the terms “incoupler,” “exit pupil expander,” and “outcoupler” will be understood to refer to any type of optical grating structure, including, but not limited to, diffraction gratings, holograms, holographic optical elements (e.g., optical elements using one or more holograms), volume diffraction gratings, volume holograms, surface relief diffraction gratings, and/or surface relief holograms. In some embodiments, a given incoupler, exit pupil expander, or outcoupler is configured as a transmissive grating (e.g., a transmissive diffraction grating or a transmissive holographic grating) that causes the incoupler, exit pupil expander, or outcoupler to transmit light and to apply designed optical function(s) to the light during the transmission. In some embodiments, a given incoupler, exit pupil expander, or outcoupler is a reflective grating (e.g., a reflective diffraction grating or a reflective holographic grating) that causes the incoupler, exit pupil expander, or outcoupler to reflect light and to apply designed optical function(s) to the light during the reflection. In other embodiments, a given incoupler, exit pupil expander, or outcoupler includes one or more reflective mirror facets. For example, the incoupler, exit pupil expander, or the outcoupler includes a set of partially reflective mirror facets with the same or with different reflection-to-transmission ratios.

The incoupler 212 is configured to receive the light 220 from the light engine 204 and direct the light 220 into the waveguide 210. In some embodiments, the incoupler 212 is defined by a smaller dimension (i.e., width) and a larger orthogonal dimension (i.e., length) with a first edge that is in the optical path toward the outcoupler 214 and a second edge that is on the opposite side of the optical path toward the outcoupler 214. In some embodiments, the “incoupler region” is defined as the region of the waveguide 210 between the first edge and the second edge. Similarly, the “outcoupler region” is defined as the region of the waveguide occupied by the outcoupler 214. In the present example, the light 220 received at the incoupler 212 is relayed to the outcoupler 214 via the waveguide 210 using TIR. A portion of the light 220 is then output to the eye 216 of a user via the outcoupler 214. Also, in some embodiments, an exit pupil expander (not shown in FIG. 2), such as a fold or other optical grating, is arranged in an intermediate stage between incoupler 212 and outcoupler 214 to receive light that is coupled into waveguide 210 by the incoupler 212, expand the light in one dimension, and redirect the light towards the outcoupler 214, where the outcoupler 214 then couples the light out of waveguide 210. In some embodiments, the exit pupil expander and the outcoupler 214 are integrated into a common component. As described above, in some embodiments, the waveguide 210 is implemented in an optical combiner as part of a lens, such as one of the lens elements 108, 110 of FIG. 1.

The waveguide 210 further includes two major surfaces 250, 252, with major surface 250 being world-side (i.e., the surface farthest from the user) and major surface 252 being eye-side (i.e., the surface closest to the user). In some embodiments, the waveguide 210 is between a world-side lens and an eye-side lens, which form lens elements 108, 110 shown in FIG. 1, for example. In some embodiments, the incoupler 212 and the outcoupler 214 are located, at least partially, at the major surface 250. In another embodiment, the incoupler 212 and the outcoupler 214 are located, at least partially, at the major surface 252.

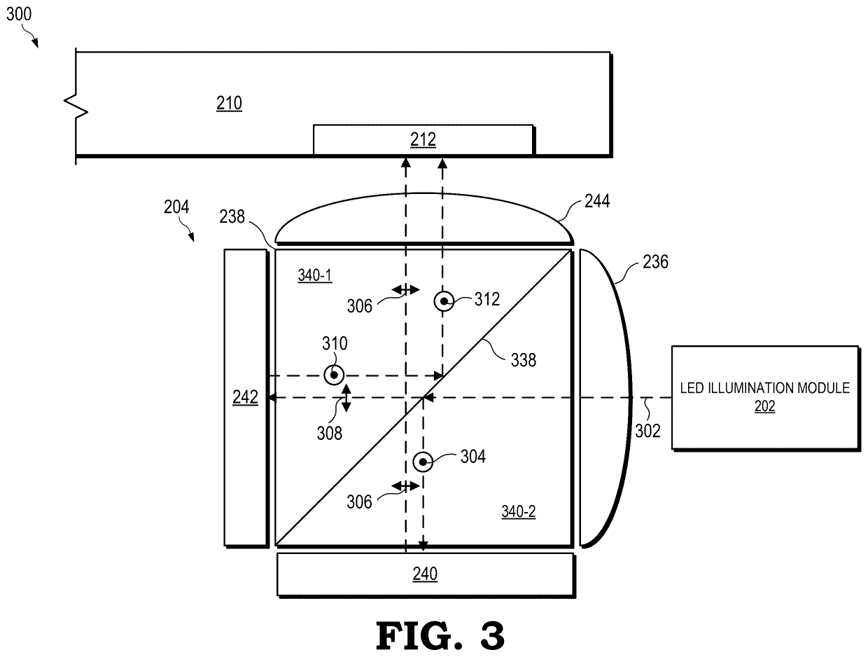

FIG. 3 shows an example of the light engine 204 of the projection system 200 of FIG. 2 in accordance with some embodiments. The light engine 204 includes a dual LCoS light engine system that achieves full polarization utilization of the light emitted from the one or more LEDs in the LED illumination module 202 (corresponding to the light source 202 of FIG. 2) through the use of two LCoS panels 240, 242 in combination with the PBS cube 238, thereby increasing the optical efficiency of the system. That is, the two LCoS panels 240, 242 receive orthogonal polarization states as determined by the orientation of the polarization beam splitter cube's 238 diagonal surface 338. As a result, 100% of the light emitted from the one or more LEDs in the LED illumination module 202 is utilized in this system. A first lens 236 relays light from the LED illumination module 202 toward the PBS cube 238 and eventually onto the two LCoS panels 240, 242. A second lens 244 then creates an exit pupil with an image projected from the LCoS panels 240, 242, forming at infinity. In some systems, these imaging functions may be achieved with multiple additional lens elements that are not shown in FIG. 3 for clarity purposes.

The LED illumination module 202 includes one or more LEDs that emit light 302. The light 302 emitted from the LED illumination module is unpolarized light. The light 302 from the LED illumination module 202 is transmitted through the first lens 236, which relays the light to the diagonal surface 338 of the PBS cube 238. The PBS cube 238 is an optical component that reflects or transmits light based on its polarization. As shown in the illustrated embodiment, the PBS cube 238 includes two right-angle prisms 340-1, 340-2 that are joined together at the diagonal surface 338. The diagonal surface 338 includes a polarization-selective coating. When the unpolarized light 302 enters the PBS cube 238, it is incident on the diagonal surface 338. The diagonal surface 338 reflects light 304 having a first polarization state (in this example, s-polarized light) and transmits light 308 having a second polarization state (in this example, p-polarized light). Thus, the diagonal surface 338 splits the unpolarized light 302 into two separate light paths having different polarization states.

Continuing with the reflected light 304 having the first polarization state, the light 304 is directed to a first LCoS panel 240, which is configured to reflect the light 304 having the first polarization state (that is, in this example, the first LCoS panel 240 is configured to reflect s-polarized light) as light 306 having the second polarization state (e.g., p-polarized light) back to the PBS cube 238. Thus, the light 306 reflected from the first LCoS panel 240 is now in the second polarization state when incident on the diagonal surface 338 of the PBS cube 238 and is transmitted through the diagonal surface 338 and exits the PBS cube 238 as light having the second polarization state 306 through the second lens 244, which focuses the light 306 on the incoupler 212 of the waveguide 210.

Now referring back to the transmitted light 308 having the second polarization state that is initially transmitted through the diagonal surface 338, the light 308 having the second polarization state is directed to the second LCoS panel 242, which is configured to reflect the light 308 having the second polarization state (that is, in this example, the second LCoS panel 242 is configured to reflect p-polarized light) as light 310 having the first polarization state (e.g., s-polarized light) back to the PBS cube 238. Thus, the light 310 reflected from the second LCoS panel 242 is now in the first polarization state when incident on the diagonal surface 338 of the PBC cube 238, so it is reflected by the diagonal surface 338 out of the PBS cube 238 as light 312 and through the second lens 244, where the light 312 is focused on the incoupler 212 of the waveguide 210.

In some embodiments, by employing the light engine 204, an unpolarized exit pupil is formed, which is atypical for an LCoS-based projector system. However, this has several benefits if the light engine 204 is paired with a waveguide 210 that employs diffractive gratings (e.g., if the incoupler 212 is a diffractive grating incoupler). While diffractive waveguides are typically more efficient for one linear polarization, this also means that a polarized light engine must be carefully aligned to this optimal polarization axis. An unpolarized system is less sensitive to misalignment and can have looser tolerances. The same is true for uniformity—a polarized system will experience more variable uniformity part-to-part than an unpolarized system with the same tolerances.

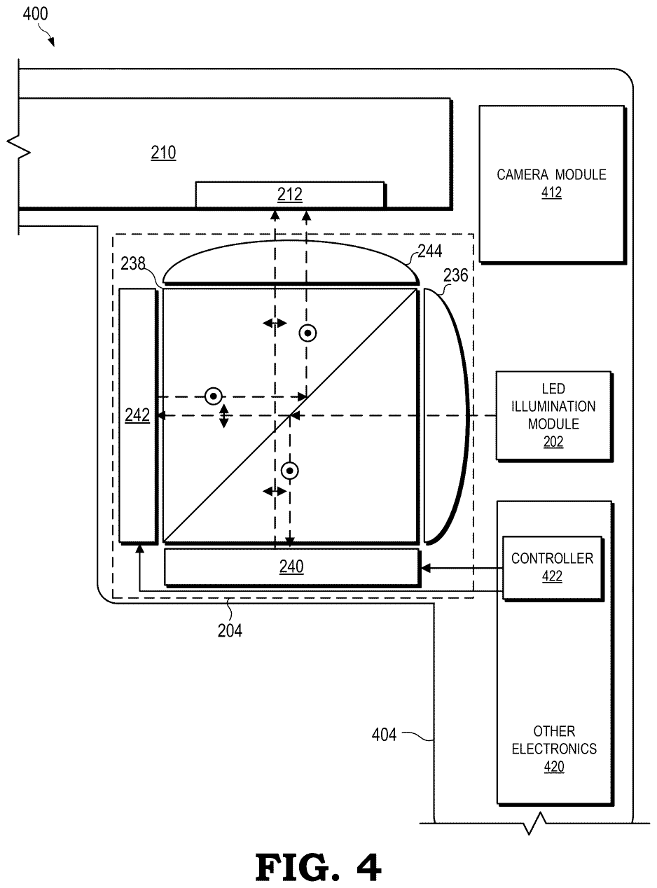

In some embodiments, the light engine 204 is geometrically calibrated to align the images from the two LCoS panels 240, 242. One example alignment technique for the final calibrated states of the two display images is a pixel-to-pixel alignment. In the pixel-to-pixel alignment, the two LCoS panels 240, 242 are mechanically or software calibrated (e.g., via a controller such as the controller 422 of FIG. 4) to have overlapping pixels. Another example alignment technique for the final calibrated states of the two display images is out-of-phase pixel alignment. In the out-of-phase pixel alignment, the two display panels are mechanically or software calibrated (e.g., via a controller such as the controller 422 of FIG. 4) to have overlapping pixels out of phase, which can enable twice the spatial frequency to be displayed by the system. For example, a controller controls the two LCoS panels 240, 242 so that the pixels of the first LCoS panel 240 overlap with the pixels from the second LCoS panel 242 out of phase so that the first LCoS panel 240 modulates light with a first phase pattern and the second LCoS panel 242 modulates light with a phase shift (e.g., a 180°phase difference) with respect to the first phase pattern. By applying a phase shift and overlapping the pixels in this manner, the spatial frequency of the display system is doubled, which results in higher resolution of the virtual content delivered to the user.

Thus, the combination of the two LCoS panels 240, 242 and the PBS cube 238 is able to achieve full polarization utilization of the unpolarized light 302 emitted by the one or more LEDs of the LED illumination module 202 by employing two polarization paths in the manner described above. This increases the optical efficiency of the display system and allows for a more compact light engine compared to conventional techniques that do not employ a two-LCoS panel system. That is, unlike the conventional polarization recycling methods in LCoS projectors, the dual LCOS panel technique illustrated in FIG. 3 does not increase system volume substantially. This is a dramatic benefit in applications such as AR glasses, where product weight and form factor are critical. An example of the compact form factor achievable in AR glasses is shown in FIG. 4.

FIG. 4 shows the integration of the light engine system employing the dual LCoS panels described in FIGS. 2 and 3 into an AR eyewear display shoulder/temple region (e.g., region 112 of FIG. 1) 400 in accordance with some embodiments. In FIG. 4, the hinge is not drawn for clarity purposes. The compact layout of the polarization recycling strategy shown enables a minimal volume industrial design to be preserved while still dramatically improving efficiency. In the illustrated embodiment, the AR eyewear display shoulder/temple region 400 also includes a camera module 412 and other electronics 420 in the temple region. The other electronics 420, for example, include a controller 422 configured to control the operation of the LED illumination module 202 and the LCoS panels 240, 242. In some embodiments, the other electronics 420 also include other components such as a battery, other sensors, speakers, microphones, or the like.

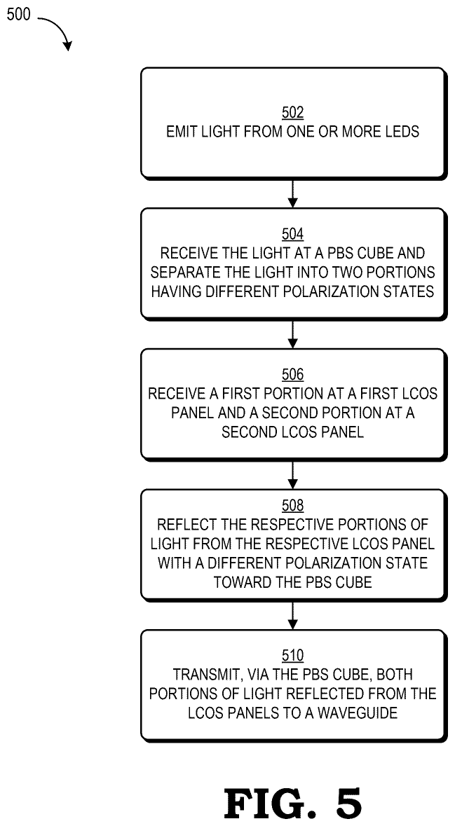

FIG. 5 shows an example of a flow chart 500 describing a method in accordance with some embodiments.

At block 502, one or more LEDs in an LED illumination module (such as the light source 202 of FIGS. 2 and 3) emit display light. In some embodiments, the display light emitted from the LEDs is unpolarized.

At block 504, the display light emitted from the one or more LEDs is received at a PBS cube (such as the PBS cube 238). The PBS cube has a diagonal surface (such as diagonal surface 338) that separates the display light into a first portion having a first polarization state and a second portion having a second polarization state. For example, the diagonal surface of the PBS cube transmits light (i.e., lets light pass through) having a first polarization state and reflects light having a second polarization state. For example, if the PBS cube is an s-polarizing beam splitter, then the diagonal surface of the PBS cube transmits light having an s-polarization state and reflects light having a p-polarization state.

At block 506, the first portion of light having the first polarization state is received at a first LCoS panel (e.g., one of LCoS panels 240, 242), and the second portion of light having the second polarization state is received at a second LCoS panel (e.g., the other one of the LCoS panels 240, 242). For example, referring to FIG. 3, the second LCoS panel 242 receives the first portion of the light having the first polarization state that passes through the diagonal surface 338 of the PBS cube 238, and the first LCoS panel 240 receives the second portion of the light having the second polarization state that is reflected from the diagonal surface 338 of the PBS cube 238.

At block 508, each LCoS panel converts the respective portion of light incident thereon to light having a different polarization state and reflects it toward the PBS cube. For example, referring to FIG. 3, the first LCoS panel 240 reflects the second portion of light having the second polarization incident thereon back toward the PBS cube 238 as light having the first polarization state, and the second LCoS panel 242 reflects the first portion of light having the first polarization incident thereon back toward the PBS cube 238 as light having the second polarization state.

At block 510, the PBS cube directs the respective portions of light reflected from the LCoS panels toward the waveguide. For example, referring to FIG. 3, the diagonal surface 338 of the PBS cube 228 allows the light having the first polarization state reflected from the first LCoS panel 240 to pass through toward the waveguide 210 (via the lens 244) and the diagonal surface 338 of the PBS cube 228 reflects the light having the second polarization state reflected from the second LCoS panel 242 toward the waveguide 210 (via the lens 244).

In some embodiments, certain aspects of the techniques described above may be implemented by one or more processors, processing circuitry, or controllers of a processing system executing software. The software comprises one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid-state storage devices such as Flash memory, a cache, random access memory (RAM), or other non-volatile memory device or devices, and the like. The executable instructions stored on the non-transitory computer-readable storage medium may be in source code, assembly language code, object code, or other instruction format that is interpreted or otherwise executable by one or more processors.

A computer-readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified, and all such variations are considered within the scope of the disclosed subject matter. Accordingly, the protection sought herein is as set forth in the claims below.

What is claimed is:

1. A light engine for an eyewear display, the light engine comprising:
a first liquid crystal on silicon panel comprising a first array of pixels configured to receive a first portion of light from an unpolarized light source; and
a second liquid crystal on silicon panel arranged orthogonally to the first liquid crystal on silicon panel, wherein the second liquid crystal on silicon panel comprises a second array of pixels and is configured to receive a second portion of light from the unpolarized light source, and
wherein the first liquid crystal on silicon panel and the second liquid crystal on silicon panel each are configured to reflect light incident thereon toward an incoupler of a waveguide of the eyewear display, and wherein light reflected from the first array of pixels of the first liquid crystal on silicon panel is aligned with light reflected from the second array of pixels of the second liquid crystal on silicon panel.

2. The light engine of claim 1, wherein the first portion of light is light having a first polarization, and the first liquid crystal on silicon panel is configured to reflect the light having the first polarization as light having a second polarization, and wherein the second portion of light is light having the second polarization, and the second liquid crystal on silicon panel is configured to reflect the light having the second polarization as light having the first polarization.

3. The light engine of claim 2, further comprising:
a polarization beam splitter cube, wherein the first liquid crystal on silicon panel is arranged on a first side of the polarization beam splitter cube and the second liquid crystal on silicon panel is arranged on a second side of the polarization beam splitter cube.

4. The light engine of claim 3, wherein the polarization beam splitter cube comprises a diagonal surface configured to reflect light having the first polarization and transmit light having the second polarization.

5. The light engine of claim 3, further comprising one or more light emitting diodes configured to emit light toward a third side of the polarization beam splitter cube, wherein a diagonal surface of the polarization beam splitter cube is configured to reflect the first portion of the light emitted from the one or more light emitting diodes having the first polarization toward the first liquid crystal on silicon panel and transmit the second portion of the light emitted from the one or more light emitting diodes having the second polarization toward the second liquid crystal on silicon panel.

6. The light engine of claim 5, wherein the first liquid crystal on silicon panel reflects the first portion of light back to the polarization beam splitter cube as a reflected first portion of light having the second polarization, wherein the reflected first portion of light having the second polarization is transmitted through the diagonal surface of the polarization beam splitter cube and through a fourth side of the polarization beam splitter cube toward the incoupler.

7. The light engine of claim 6, wherein the second liquid crystal on silicon panel reflects the second portion of light back to the polarization beam splitter cube as a reflected second portion of light having the first polarization, wherein the reflected second portion of light having the first polarization is reflected by the diagonal surface of the polarization beam splitter cube through the fourth side of the polarization beam splitter cube toward the incoupler.

8. The light engine of claim 3, further comprising:
a first lens arranged on a third side of the polarization beam splitter cube, the third side of the polarization beam splitter cube facing a direction toward one or more light emitting diodes; and
a second lens arranged on a fourth side of the polarization beam splitter cube, the fourth side of the polarization beam splitter cube facing a direction toward the incoupler of the waveguide.

9. An eyewear display, comprising:
one or more light emitted diodes (LEDs) configured to emit light; and
a light engine comprising:
a first liquid crystal on silicon panel comprising a first array of pixels arranged orthogonally to a second liquid crystal on silicon panel comprising a second array of pixels,
wherein the first liquid crystal on silicon panel is configured to receive a first portion of light emitted from the one or more LEDs, and wherein the second liquid crystal on silicon panel is configured to receive a second portion of light emitted from the one or more LEDs, and
wherein the first liquid crystal on silicon panel and the second liquid crystal on silicon panel are configured to reflect light incident thereon toward an incoupler of a waveguide of the eyewear display, and wherein light reflected from the first array of pixels of the first liquid crystal on silicon panel is aligned with light reflected from the second array of pixels of the second liquid crystal on silicon panel.

10. The eyewear display of claim 9, wherein the first portion of light is light having a first polarization, and the first liquid crystal on silicon panel is configured to reflect the light having the first polarization as light having a second polarization, and wherein the second portion of light is light having the second polarization, and the second liquid crystal on silicon panel is configured to reflect the light having the second polarization as light having the first polarization.

11. The eyewear display of claim 10, the light engine further comprising:
a polarization beam splitter cube, wherein the first liquid crystal on silicon panel is arranged on a first side of the polarization beam splitter cube and the second liquid crystal on silicon panel is arranged on a second side of the polarization beam splitter cube, wherein the one or more light emitting diodes are positioned facing a third side of the polarization beam splitter cube.

12. The eyewear display of claim 11, wherein the polarization beam splitter cube comprises a diagonal surface configured to reflect light having the first polarization and transmit light having the second polarization.

13. The eyewear display of claim 12, wherein the diagonal surface of the polarization beam splitter cube is configured to reflect the first portion of the light emitted from the one or more light emitting diodes having the first polarization toward the first liquid crystal on silicon panel and transmit the second portion of the light emitted from the one or more light emitting diodes having the second polarization toward the second liquid crystal on silicon panel.

14. The eyewear display of claim 13,
wherein the first liquid crystal on silicon panel reflects the first portion of light back to the polarization beam splitter cube as a reflected first portion of light having the second polarization, wherein the reflected first portion of light having the second polarization is transmitted through the diagonal surface of the polarization beam splitter cube and through a fourth side of the polarization beam splitter cube toward the incoupler, and
wherein the second liquid crystal on silicon panel reflects the second portion of light back to the polarization beam splitter cube as a reflected second portion of light having the first polarization, wherein the reflected second portion of light having the first polarization is reflected by the diagonal surface of the polarization beam splitter cube through the fourth side of the polarization beam splitter cube toward the incoupler.

15. The eyewear display of claim 11, further comprising:
a first lens arranged on the third side of the polarization beam splitter cube; and
a second lens arranged on a fourth side of the polarization beam splitter cube, the fourth side of the polarization beam splitter cube facing a direction toward the incoupler.

16. A method comprising:
receiving, at a first liquid crystal on silicon panel comprising a first array of pixels, a first portion of display light having a first polarization and reflecting the first portion of display light to an incoupler of a waveguide; and
receiving, at a second liquid crystal on silicon panel orthogonal to the first liquid crystal on silicon panel and comprising a second array of pixels, a second portion of the display light having a second polarization and reflecting the second portion of display light to the incoupler,
wherein light reflected from the first array of pixels of the first liquid crystal on silicon panel is aligned with light reflected from the second array of pixels of the second liquid crystal on silicon panel.

17. The method of claim 16, further comprising:
emitting the display light from a light emitting diode illumination module through a first lens toward a polarization beam splitter cube;
receiving the display light at a diagonal surface of the polarization beam splitter cube; and
separating, at the diagonal surface of the polarization beam splitter cube, the display light into the first portion of display light having the first polarization and the second portion of display light having the second polarization.

18. The method of claim 17, further comprising:
transmitting, through the diagonal surface, the first portion of the display light having the first polarization toward the first liquid crystal on silicon panel; and
reflecting, via the diagonal surface, the second portion of the display light having the second polarization toward the second liquid crystal on silicon panel.

19. The method of claim 18, further comprising:
receiving, at the first liquid crystal on silicon panel, the first portion of the display light having the first polarization and reflecting the first portion back toward the diagonal surface as light having the second polarization; and
receiving, at the second liquid crystal on silicon panel, the second portion of the display light having the second polarization and reflecting the second portion back toward the diagonal surface as light having the first polarization.

20. The method of claim 19, further comprising:
receiving, at the diagonal surface, the first portion of the display light having the second polarization and reflecting the first portion of the display light having the second polarization toward the waveguide through a second lens; and
receiving, at the diagonal surface, the second portion of the display light having the first polarization and transmitting the second portion having the first polarization toward the waveguide through the second lens.
